(19) United States
(12) Patent Application Publication
(10) Pub. No.: US 2008/0075800 A1
(43) Pub. Date: Mar. 27, 2008

(54) EQUIPMENT FOR THE MANUFACTURE OF CERAMIC SANITARY WARES

(75) Inventors: Domenico Bambi, Budrio (Bologna) (IT); Giorgio Sarani, Borgo Tossignano (Bologna) (IT)

Correspondence Address: PEARNE & GORDON LLP, 1801 EAST 9TH STREET, SUITE 1200, CLEVELAND, OH, 44114-3108, US

(73) Assignee: SACMI COOPERATIVA MECCANICI IMOLA SOCIETA' COOPERATIVA, Imola (Bologna) (IT)

(21) Appl. No.: 11/861,052

(22) Filed: Sep. 25, 2007

(30) Foreign Application Priority Data
Sep. 27, 2006 (IT) BO2006A000660

(51) Int. Cl. B28B 3/00; B28B 17/00

(52) U.S. Cl. 425/233

(57) ABSTRACT

Ceramic sanitary wares are cast using equipment that comprises at least one mold made up of two halves presenting relative cavities in which the cast item is formed, rendered capable of movement to and fro along a predetermined direction toward and away from one another through the agency of a first actuator, in such a way that respective mating surfaces of the mold halves can be joined together or separated. Pressure forces acting on the mold halves from within are contained and controlled by a system associated directly with the mold halves, which comprises a mechanism acting on the system itself and on the halves of the mold in such a way as to create a gap affording a free passage to the mold halves when drawn together and distanced one from another. In this way, at least one of the halves can be rendered independent of the containment and control system for demolding purposes.

### BACKGROUND OF THE INVENTION

The present invention relates to equipment for manufacturing sanitary wares made of ceramic material.

In the art field concerned with the manufacture of ceramic sanitary wares (such as wash basins, water-closet bowls, bidets, etc.), the most familiar and widely used production method is that of preparing a fluid mix (known as a slip, composed of an aqueous component, and a clay component held in suspension), then pouring the mix into respective slip-casting molds that present a structure conventionally of porous nature, fashioned typically from resins.

Such porous molds are made up of at least two halves (“male” and “female”), joinable together or insertable one into the other to create an internal cavity from which the cast item takes its form.

The two or more parts of the mold are incorporated into special systems, diversified structurally (according to the type of piece being cast) and composed generally of at least:

a frame supporting the various parts of the mold;

motion-inducing and positioning means by which the parts of the mold can be moved at least toward and away from one another in such a way as to allow the release of the cast item when demolded;

feed components by which the slip is directed into the closed mold.

Among the known properties of the porous resin mold, moreover, is a relatively high mechanical strength that allows the adoption of pressure slip casting methods, that is to say, procedures whereby the slip is caused to enter the mold and then solidify to the required thickness, under high pressures (generally between 3 and 15 bar).

Under these high internal pressures, however, forces are generated perpendicularly to the casting surfaces presented by the parts of the mold, and deformation of the mold becomes a potential risk: the directions assumed by the components of the internal forces include both the direction along which the parts of the mold are joined and closed, and directions orthogonal (hence transverse) to the closing direction.

Accordingly, these forces need to be offset by suitable devices that will ensure their containment:

as concerning the forces generated in the closing direction of the mold, the slip-casting systems outlined above may (in the case of one prior art solution) utilize a fixed platen to which one half of the mold is attached, and a cylinder acting on a movable platen to which the other half of the mold is attached;

in the case of the forces generated in directions orthogonal to the closing direction, on the other hand, the present applicant has developed and implemented a device for the containment of such forces (disclosed in EP 1 043 132), wherein one half of the mold is equipped with a frame delimiting a space, between the selfsame frame and the mold half, such as will accommodate an element inflatable with a fluid and designed, operating from externally of the mold, to cushion the forces generated by the pressure of the slip directed into the cavity.

With this system, in effect, control over the pressure of the fluid within the inflatable element can be adapted continuously to the pressure of the slip, so as to optimize the reaction and consequently avoid potential deformation of the mold, while attenuating any elastic contraction occurring in the mold wall.

Thus, the containment device in question provides an optimum solution to the problem of containing the transverse forces in play during the casting process, but is still subject to marked limitations on the practical level, identifiable both in the considerable weight of the components employed, and in the fact that interstitial spaces between the mating halves of the mold are occupied by an element of indeterminate geometry.

More exactly, the weight of the combined mold-and-containment device structure is considerable, and such as can be carried only by certain types of systems, typically multiple-mold type frames for casting wash basins, whereas systems where molds are required to interact and move independently (for example, systems for casting water closet bowls with rim, where one half of a mold—containing the rim—must be transferred from the casting station to a further station where the rim is bonded to the bowl) cannot be equipped with a containment device of this type.

An added drawback is that certain molds (like the mold in which the aforementioned rim is cast) cannot be equipped with the containment device by reason of their male-female type geometry, with one part insertable into the other part.

Yet another drawback is that many systems using batteries of molds essentially “traditional” in embodiment (i.e. without the inflatable element), tend to be affected by problems deriving in essence from the application of rigid and fixed containment systems (frames) to at least one of the mold halves. This type of architecture produces drawbacks similar to those mentioned above, that is to say limited maneuverability due to the weight of the mold/containment device assembly, with the result that the operation of changing the mold is rendered slow and difficult, as the containment structure must be dismantled completely from the mold currently in use before being fitted to a new or reconditioned mold. This renders the slip casting system subject to extended down times while in service.

Accordingly, the object of the invention is to develop and implement equipment for manufacturing sanitary wares of which the structural characteristics will allow its use in any type of casting system, whatever the geometry of the item being cast, and to render the component parts of the mold swiftly and safely movable or slidable one relative to another while maintaining the characteristics of mechanical safety afforded by previous solutions.

### SUMMARY OF THE INVENTION

The stated object is realized according to the invention in equipment for manufacturing ceramic sanitary wares comprising a mold made up of at least two halves presenting relative cavities in which the ware is formed, rendered capable of reciprocating movement along a predetermined direction toward and away from one another through the agency of first motion-inducing means, in such a way that respective mating surfaces of the mold can be joined to or distanced from one another.

The equipment disclosed comprises means associated with and serving to contain and control the forces acting on the mold halves, incorporating release means designed to act on the selfsame containment and control means and on the halves of the mold in such a way as to create a gap by which the mold halves are afforded a free passage when moving toward or away from one another, thereby rendering at least one of the halves independent of the containment and control means.

### BRIEF DESCRIPTION OF THE DRAWINGS

The invention will now be described in detail, by way of example, with the aid of the accompanying drawings, in which:

FIGS. 1 and 2 show an example of equipment for manufacturing ceramic wares according to the present invention, illustrated respectively in a closed operating configuration of contact between halves of a mold forming part of the equipment, and in an open operating configuration, viewed schematically in side elevation and with certain parts omitted better to reveal others;

FIG. 3 shows part of the equipment in FIG. 2, illustrated in a front view with certain parts omitted and others in section;

FIGS. 4 and 5 show details P and P1 of FIGS. 2 and 1, respectively, consisting in a part of control means by which to contain the forces acting on the mold in two different configurations, at rest and in operation, both illustrated in a front view with certain parts omitted and others in section;

FIG. 6 shows a variation in embodiment of the equipment disclosed, illustrated schematically in a front view with certain parts omitted better to reveal others;

FIG. 7 shows a further variation in embodiment of the equipment disclosed, illustrated schematically in a front view with certain parts omitted better to reveal others;

FIG. 8 is an enlarged detail A of FIG. 7;

FIG. 9 shows a third variation in embodiment of the equipment disclosed, illustrated schematically in a front view;

FIG. 10 is an enlarged detail B of FIG. 9, illustrated schematically in section and in a front view;

FIG. 11 shows the equipment of FIG. 7 in a partial side elevation with certain parts omitted better to reveal others.

### DESCRIPTION OF THE PREFERRED EMBODIMENTS

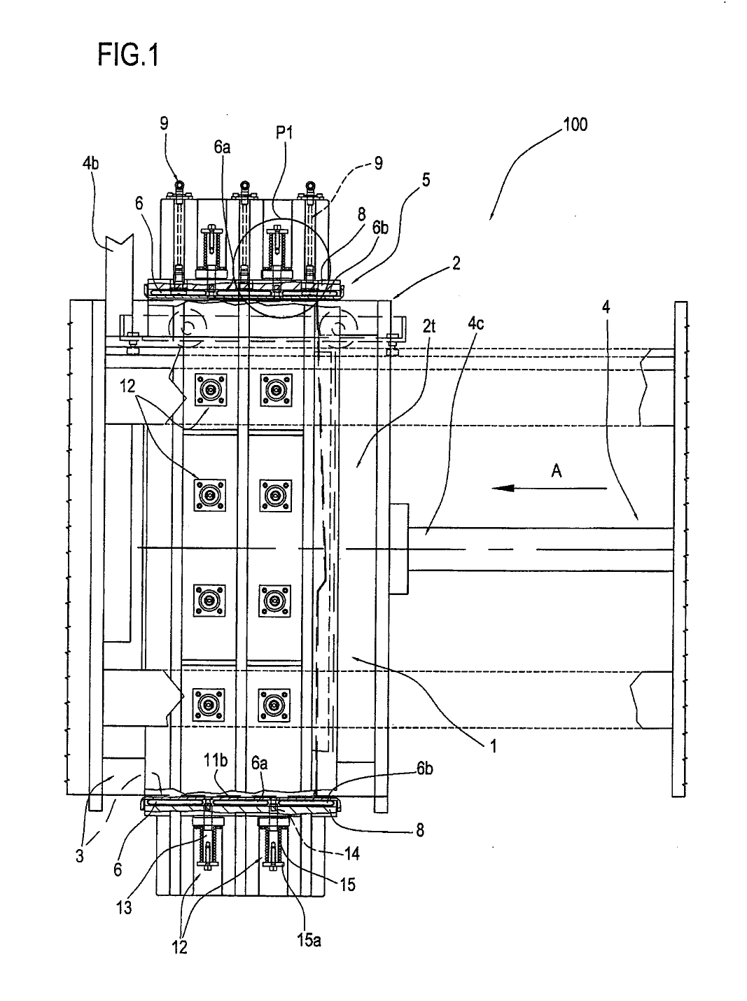

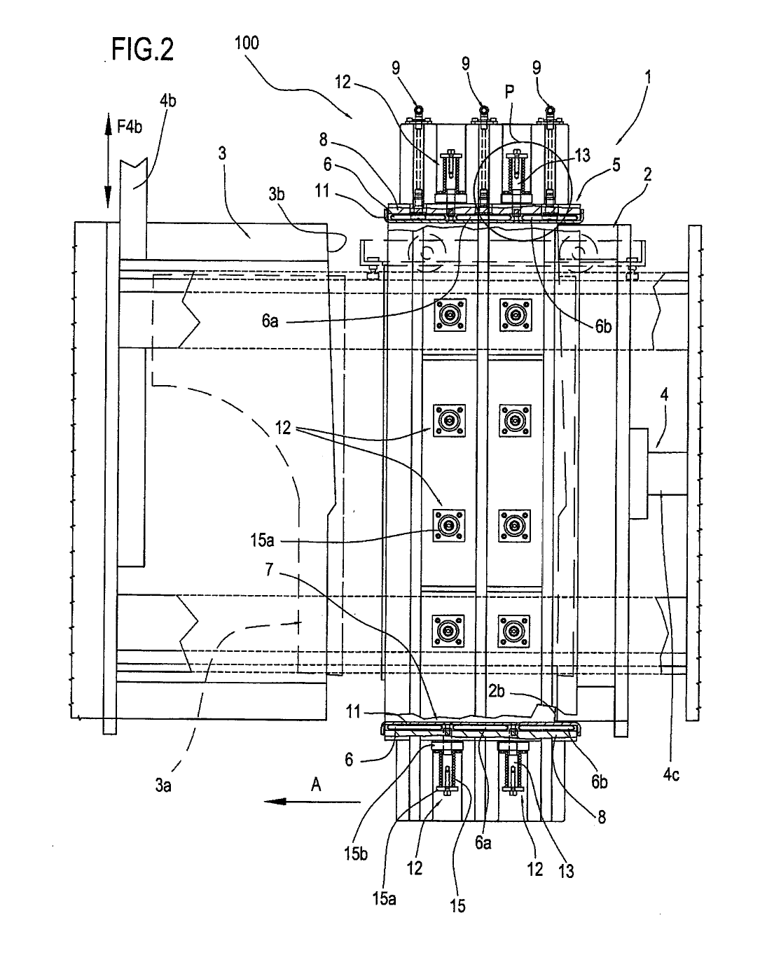

As illustrated in the accompanying drawings, and with reference in particular to FIGS. 1 and 2, the equipment to which the invention relates, denoted 100 in its entirety, is utilized in the manufacture of ceramic wares, particularly sanitary wares (such as wash basins, water-closet bowls, bidets, etc.) produced by a slip-casting process.

The equipment 100 consists in a mold 1 comprising at least two matched halves 2 and 3 (male and female, respectively), with relative cavities 2a and 3a from which the cast item takes its form; the two halves are capable of relative movement toward and away from one other, generated by relative first motion-inducing means 4 caused to reciprocate along a predetermined direction A, in such a way as to join or separate respective mating surfaces denoted 2b and 3b.

In the example of the drawings, illustrated schematically and implying no limitation, the equipment 100 is used to manufacture water-closet bowls with a rim, the mold denoted 1 being the mold used to cast the rim.

Still referring to FIGS. 1 and 2, the equipment 100 can include a cylinder 4c by which motion is induced in one mold half 2 (so as to direct this same half 2 toward and away from the other mold half 3), and second motion-inducing means consisting in a pair of arms 4b by which one mold half 3 (the half containing the cast rim) can be lifted vertically (see arrows F4b) and positioned on a further mold (not illustrated) used to cast the bowl, whereupon the two castings are bonded by a conventional procedure.

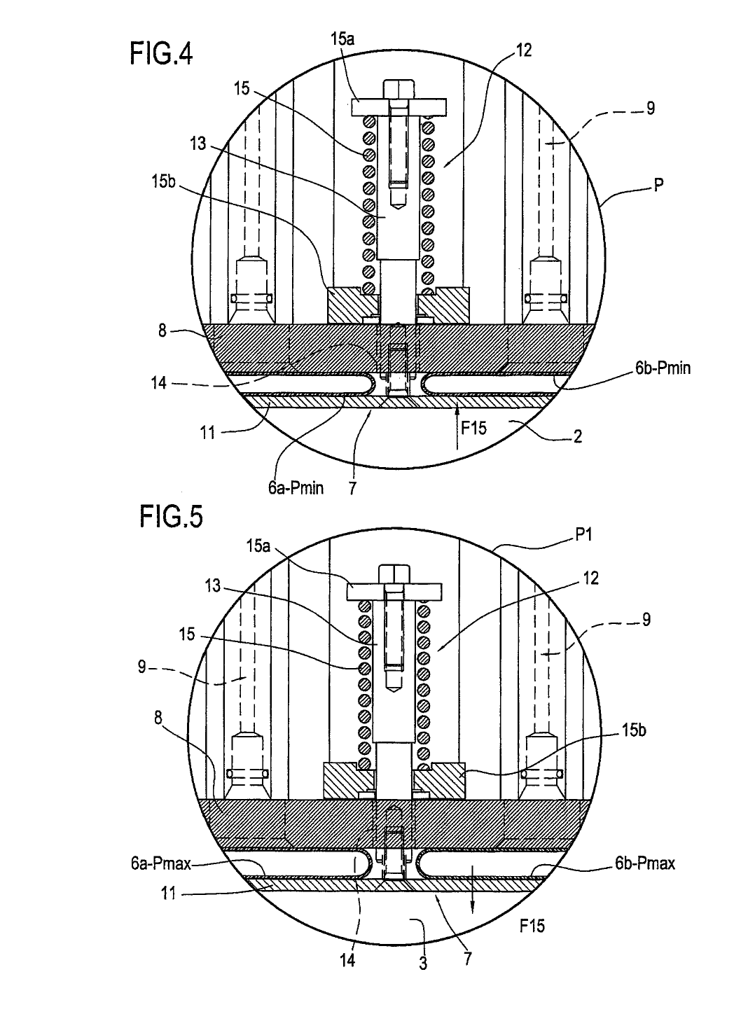

In addition, the equipment 100 can include means 5 by which to contain and control the forces acting on the halves 2 and 3 of the mold 1 (in the course of the casting steps), arranged around the mold cavities 2a and 3a and comprising, in the first example of FIGS. 1 to 6, at least one inflatable element 6 filled with a quantity of pressurized fluid such as will produce a first limit configuration of minimum pressure Pmin and contracted dimensions, when at rest (see FIG. 4), and a second limit configuration of maximum pressure Pmax and expanded dimensions, when in operation (see FIG. 5).

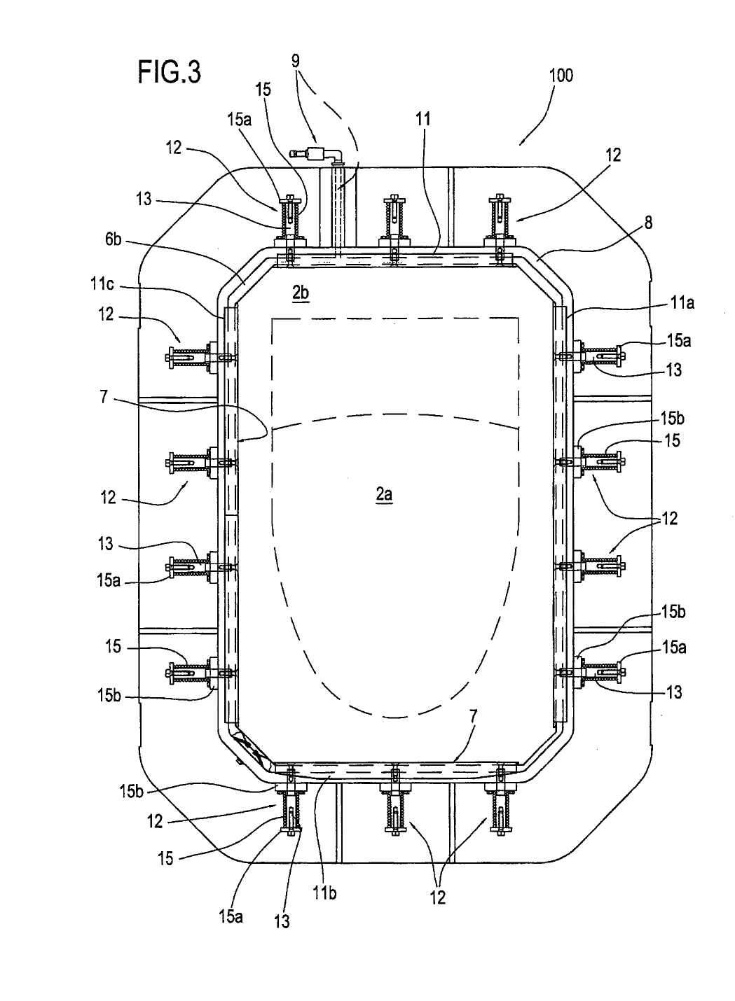

As illustrated in FIGS. 3 to 5 and 7 to 10, the aforementioned containment and control means 5 further comprise, at least, release means 7 acting on these same means 5 and on the halves 2 and 3 of the mold 1 in such a manner as to create a gap through which the two halves 2 and 3 can pass freely when joined or distanced from one another, thereby rendering at least one of the halves 2 or 3 independent of the containment and control means 5.

Observing the structure of FIGS. 3 to 5, in particular, such release means 7 operate between the halves 2 and 3 of the mold 1 and the inflatable element 6 in such a way as to create a gap through which the mold halves 2 and 3 can pass freely when brought together or distanced one from another, thereby rendering at least one of the halves 2 or 3 independent of the containment and control means 5; this could be the half containing the cast item to be transferred to another station, as in the example illustrated.

In particular, the containment and control means 5 further comprise a first frame 8 surrounding a peripheral outer portion of both mold halves 2 and 3, when in a closed configuration of contact one with another, and supporting the inflatable element 6 internally.

More exactly, the release means 7 are interposed between the two halves 2 and 3 of the mold 1 and the inflatable element 6 and connected to the aforementioned first frame 8, so as to create a predetermined or linear gap through which the two mold halves 2 and 3 can pass freely at least when the inflatable element 6 is at rest, presenting the first limit configuration of minimum pressure and contracted dimensions.

Preferably, albeit implying no limitation, the first frame 8 will be rigidly associated with the outer surface presented by one half 2 or 3 of the mold 1, and the same first frame 8 can be equipped with two or more inflatable elements 6, 6a and 6b arranged one beside the next along the aforementioned direction A followed by the mold halves 2 and 3 when joined to and distanced from one another, so as to cover the full depth of the surfaces presented by the mold cavity.

In greater detail, constructionally, the release means 7 can comprise a movable second frame composed of at least one plate 11 matching the periphery of the first frame 8 at least in part, and associated with the selfsame first frame by way of coupling means 12 in such a way as to establish the gap affording a passage to the halves 2 and 3 of the mold 1 when joined to and distanced from one another, and when the inflatable elements 6, 6a and 6b present their first configuration of contracted dimensions.

The coupling means 12 in question can be of passive or active type.

In the case of passive coupling means, these could take the form, for example, of flexible retaining means 12 (see FIGS. 4 and 5, in particular) comprising a plurality of pins 13, each positioned on the outer surface of the first frame 8 and passing through a relative clearance socket 14 afforded by the selfsame first frame 8, in such a way that one end can be associated with the second frame.

Interposed between each pin 13 and the first frame 8 is a spring 15 serving to keep the second frame in close association with the first frame 8 when the inflatable elements 6, 6a and 6b present their first configuration of contracted dimensions and, respectively, to adjust or increase the distance between the second frame and the first frame 8 when the inflatable elements 6, 6a and 6b present their second, operating configuration of expanded dimensions (see arrows F15).

In effect, each spring 15 is retained between the pin 13 and the first frame 8 by a pair of rings 15a and 15b, a first associated with the free outer end of the pin 13 and a second seated against the first frame 8.

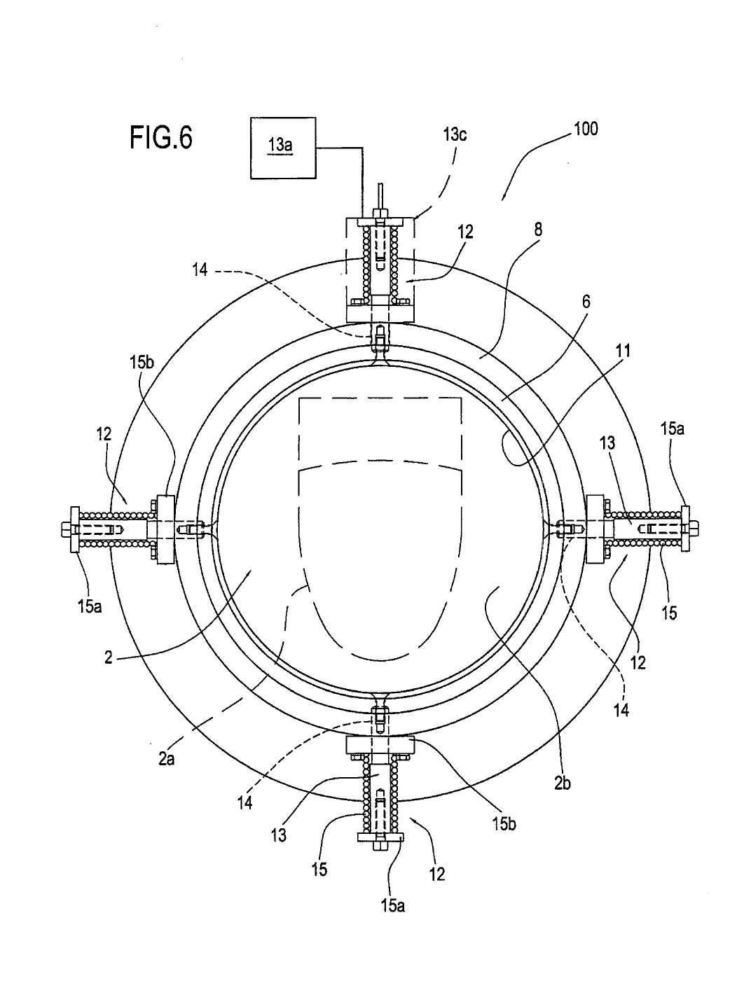

Coupling means 12 of active type could include a plurality of pneumatic cylinders 13c (one of which illustrated schematically in FIG. 6 with phantom lines, by way of example), each positioned on the outer surface of the first frame 8 and passing through a relative through socket 14 afforded by the selfsame first frame 8, in such a way that the end, or rod, can be associated with the second frame.

Each of the cylinders 13c can be governed by a control unit 13a (indicated by a block in FIG. 6) in such a way as to keep the second frame in close association with the first frame 8, through the force of the cylinders 13c, when the inflatable elements 6, 6a and 6b are in their at-rest limit configuration of contracted dimensions, and, respectively, to adjust or increase the distance between the second frame and the first frame 8 when the inflatable elements 6, 6a and 6b are in their operating limit configuration of expanded dimensions.

Constructionally, by way purely of example, the first frame 8 could present a quadrangular shape when seen in section, and the movable second frame might comprise at least four independent plates 11, 11a, 11b, and 11c associated one with each side of the first frame and furnished each with the flexible retaining means 12 described above.

Self-evidently, the shape of the first frame 8 and the number and shape of the plates 11 could be other than as described and illustrated in the accompanying drawings, depending on practical requirements and on the geometry of the molds: in FIG. 6, for example, the first frame 8 is of circular section and surrounds a mold 1 of cylindrical embodiment, whilst the plate 11 might appear as a single element matching the shape of the first frame 8, or as two elements of arched profile, designed likewise to match the geometry of a circular or cylindrical first frame 8.

Referring again to FIGS. 1 and 2, numeral 9 denotes flow and return means 9 mounted to the first frame 8, by which the inflatable elements 6, 6a and 6b are supplied with and relieved of fluid.

Such flow and return means 9, supplying air, for example, are positioned on the top part of the first frame 8 and insertable through the frame in such a way as to connect in fluid-tight association with the relative inflatable elements 6, 6a and 6b.

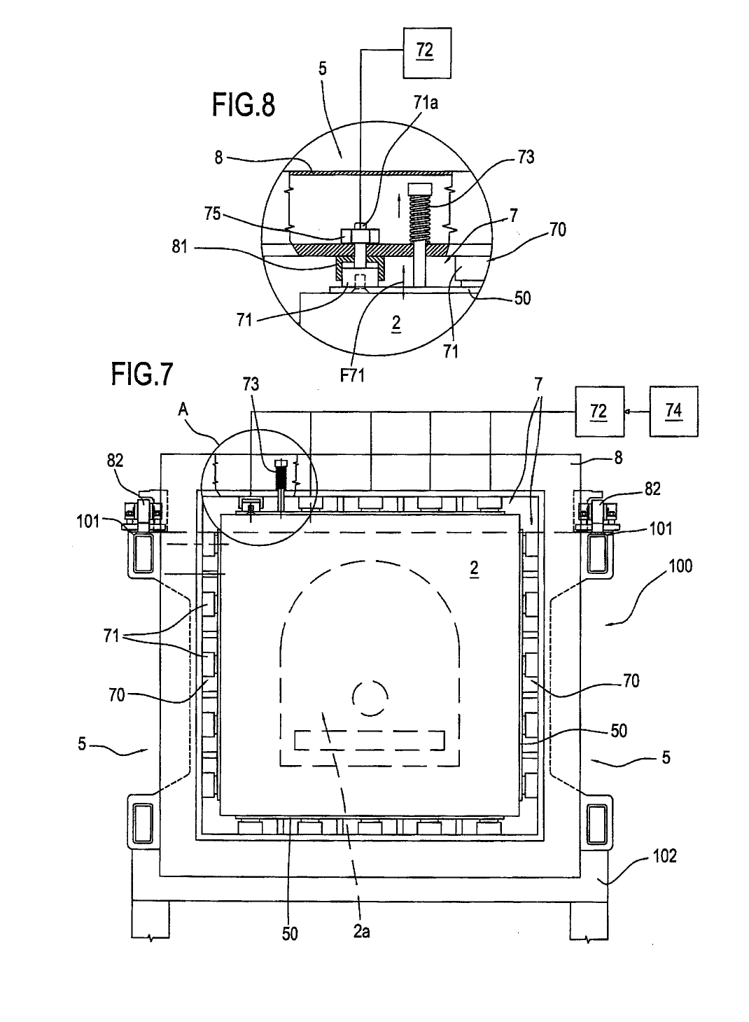

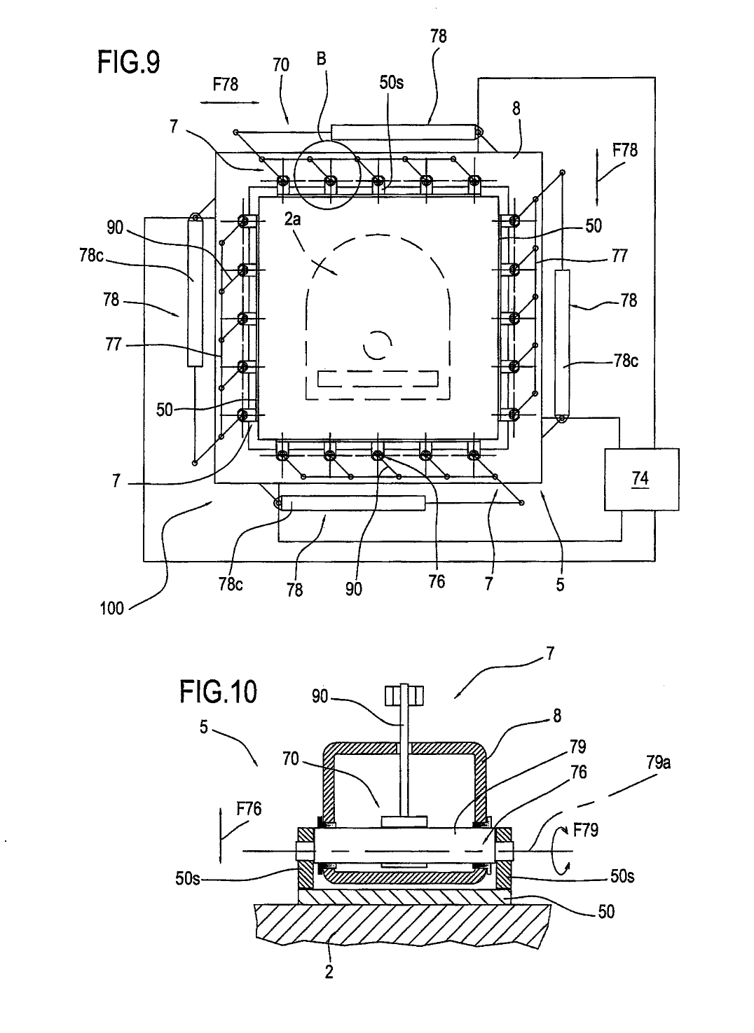

To improve the releasability of the porous mold 1 still further, the containment system of the invention is complemented by two further variations in embodiment of the equipment 100, as in FIGS. 7 and 9.

In both solutions, the release means 7 described above are interposed between the containment and control means 5 and the two mold halves 2 and 3. In these solutions, the containment and control means 5 are still embodied substantially as a first frame 8 surrounding a peripheral outer portion of both mold halves 2 and 3.

Clearly, in the interests of simplicity, both of the alternative embodiments in question could be incorporated into a casting system as described previously, albeit this does not limit the scope for application of the solution to other types of casting systems.

In the example of FIGS. 7 and 9, the containment and control means 5 are shown as comprising a plurality of locating plates 50 arranged so as to surround both of the mold halves 2 and 3 when in the contact configuration, of which the release function is the same as that performed by the plates 11 of the first solution described previously.

Similarly, release means 7 are located between the plurality of plates 50 and the first frame 8, surrounding a peripheral outer portion of both the mold halves 2 and 3, in such a way as to act on the selfsame plates 50.

Depending on the geometry of the particular mold 1, the aforementioned plates 50 can be at least two in number (in the case of a circular mold, for example, as illustrated in FIG. 6), positioned to surround the mold halves 2 and 3 peripherally when in the contact configuration.

Where the single mold halves 2 and 3 present a quadrangular peripheral outline (see FIGS. 7 and 9), the first frame 8 will be of corresponding quadrangular shape and the plates 50 at least four in number, in such a way as to surround both halves 2 and 3 of the mold peripherally when in the contact configuration.

In greater detail, these release means 7 comprise motion-inducing mechanisms 70 by means of which the plates 50 can be moved between an operating position of proximity, that is to say of contact between the plates 50 and the mold halves 2 and 3 (see also FIGS. 8 and 10), and a non-operating position of detachment, in which the plates 50 are distanced from the mold halves 2 and 3 so that the selfsame halves 2 and 3 can be separated one from another.

In the example of FIGS. 7 and 8, the motion-inducing mechanisms 70 comprise: a plurality of hydraulic cylinders 71 associated with each plate 50, and means 72 by which to activate and deactivate the cylinders 71.

Each cylinder 71 is associated slidably with a relative mounting 81 presented by the innermost surface of the first frame 8, and anchored by way of a free end to the relative plate 50.

The means 72 of activating and deactivating the cylinders 71 are connected to the selfsame cylinders 71, and able thus to determine the positions in which the plates 50 are in proximity to and distanced from the mold halves 2 and 3 (see arrows F71, FIG. 8).

In the event of the hydraulic cylinders 71 being single-acting, the motion-inducing mechanisms 70 might also comprise spring return means 73, interposed between the first frame 8 and each plate 50 so as to enable the passage of the plate 50 from the position of proximity to the distanced position (see FIG. 8).

With regard to the means 72 of activating and deactivating the cylinders 71, these same means 72 can be governed by a master controller 74 such as will allow of varying the reaction pressure of each plate 50 on the mold halves 2 and 3 (during the casting process), by actuating the cylinders 71, thereby creating containment means of active type.

Alternatively, the rod 71a of each cylinder 71 can be furnished with an adjustable reaction and stroke-limiting element 75 (see FIG. 8), interposed between the rod 71a and the first frame 8, in such a way as to establish a predetermined travel between the position of proximity and the distanced position of the plates 50 (i.e. with a predetermined contact pressure applied to the mold halves 2, 3), thereby creating containment means of passive type.

In the example of FIGS. 9 and 10, the motion-inducing mechanisms 70 comprise: cam means 76, and operating and actuating means 78.

The cam means 76 are interposed between, the first frame 8 and each plate 50, and connected mechanically by way of relative rods 77 to the operating and actuating means 78.

The cam means 76 comprise a plurality of pivots 79 associated with the single plates 50, mounted at each end by way of respective eccentric fulcrum points 79a to vertical side members 50s of the relative plate 50, in such a way that the plate 50 can be displaced perpendicularly to the corresponding face of the mold halves 2 and 3, toward and away from the selfsame halves 2 and 3, by causing the eccentric pivots 79 to rotate through the agency of the operating and actuating means 78 (see arrows F76 and F79 in FIG. 10).

Each pivot 79 is associated with one end of a relative lever 90 connected at the other end to a common rod 77 operating all the levers associated with the plate 50.

Each rod 77 is connected in turn to the relative operating and actuating means 78.

The operating and actuating means 78 and the cam means 76 are able to determine the aforementioned positions of the plates 50 in proximity to and distanced from the mold.

The operating and actuating means 78 could include a cylinder 78c such as will induce reciprocating linear motion (see arrow F78) in each rod 77, thereby causing the plates 50 to assume the positions of proximity to and detachment from the halves 2 and 3 of the mold 1 and viceversa.

As in the example described previously, each cylinder 78c can be governed by a master controller 74 designed both to determine the stroke of the cylinder 78c in each direction, corresponding to the travel between the limits at which the plates 50 are positioned in proximity to and distanced from the mold, and to introduce a further stroke variation dependent on the reaction pressure applicable preferably to the mold halves 2 and 3 by each plate 50 (and on the steps of the casting cycle), thereby creating containment means of active type.

In the event that the containment means are of passive type, however, the single cylinders 78c will be piloted by the master controller 74 (preferably in concert, though not necessarily), to reciprocate through a stroke corresponding simply to the travel between the limits at which the plates 50 are positioned in proximity to and distanced from the mold (and viceversa).

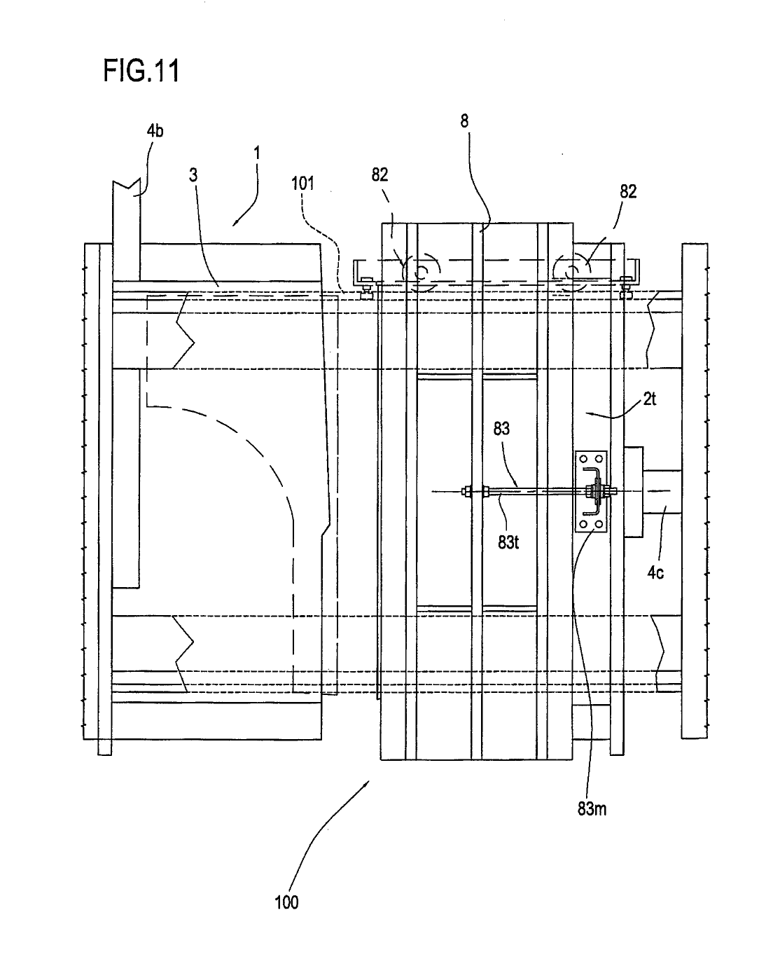

In the example of FIG. 11 (which illustrates a preferred solution, albeit implying no limitation), the first frame 8 is associated with the platen 2t of the relative mold half 2 in separable fashion, through the agency of means denoted 83.

In particular, and by way of example, implying no limitation on the type of system to which the invention might be applicable, the first frame 8 can be equipped with at least one pair of trolleys 82 running on relative rails 101 presented by the fixed frame 102 of a casting machine.

More exactly, the first frame 8 incorporates the aforementioned separable means 83 of association with one of the mold halves 2, in this instance the half denoted 2, so that the activation of the motion-inducing means 4 (the cylinder 4c anchored to the platen 2t of the mold half 2) will draw the mold halves 2 and 3 together or distance the one from the other, and when necessary, distance the first frame 8 from the mold half 2 associated with the selfsame frame 8.

Although not illustrated, the structure in question can also be applied to the first frame 8 of the solution described previously.

As discernible likewise in FIG. 11, the mold half denoted 2 (the male part by way of example, though not necessarily) is associated with the first frame 8 by way of a pair of tie bolts 83t (rigid anchor) attached at one end to the edge of the first frame 8, and at the other end to a bracket 83m presented by the platen 2t of the mold half 2: this enables synchronized motion of the two elements (frame and platen) back and forth along the clamping direction of the two mold halves and, when necessary, allows the separation of the frame and platen in the event of a mold changeover.

In an alternative solution (not illustrated), the separable fastening means 83 might consist in a pair of cylinders such as will allow a calibrated variation of the distance between the platen 2t and the first frame 8, according to the operating requirements of the system.

In essence, therefore, the equipment 100 described thus far is used in the conventional manner for manufacturing ceramic wares (the rim of a water-closet bowl, in the example illustrated), while providing a system for containment of the forces operating on a porous mold.

The characteristics of the containment means are such that the mold half in which the cast item remains seated can be released from these same means and distanced from the other mold half, then lifted and carried to a station where the rim is fitted to the bowl, unencumbered by the additional weight of the frames needed to ensure successful containment.

The characteristic of releasability presented by one part of the mold or by both parts, especially in the former instance, is afforded by the inclusion of the plates between the mold and the inflatable elements, with which it becomes possible to create a “corridor”, as it were, through which the mold parts can pass without disturbing the inflatable elements attached to the first frame.

In the latter instance, on the other hand, releasability is assured by the inclusion of hydraulic or mechanical means allowing the parts of the mold to separate one from another while keeping the containment system associated fixedly with the structure of the machine.

This means that the containment system, which in general is very heavy, can also be used in conjunction with molds of which the half that retains the demolded item has to be moved and/or supported by conventional handling systems proportioned mechanically to lift and accommodate the mold part alone, thereby avoiding the need to structure the system with bigger and bulkier lifting and handling means, at greater cost.

1. Equipment for the manufacture of ceramic wares, comprising:
at least one mold made up of at least two halves presenting relative cavities in which the ware is formed, rendered capable of reciprocating movement along a predetermined direction toward and away from one another through the agency of first motion-inducing means, in such a way that respective mating surfaces of the mold can be joined to or distanced from one another;
means associated with and serving to contain and control the forces acting on the mold halves, comprising, at least, release means acting on the selfsame containment and control means and on the halves of the mold in such a way as to create a gap by which the mold halves are afforded a free passage when moving toward or away from one another, thereby rendering at least one of the halves independent of the containment and control means.

2. Equipment as in claim 1, wherein the means of containing and controlling the forces acting on the halves of the mold are arranged around the mold cavities and comprise at least one inflatable element filled with pressurized fluid, alternating between a first limit configuration of minimum pressure and contracted dimensions, when at rest, and a second limit configuration of maximum pressure and expanded dimensions when in operation, further comprising, at least, release means forming part of the containment and control means and operating between the halves of the mold and the at least one inflatable element in such a way as to create a gap by which the mold halves are afforded a free passage when moving toward or away from one another, thereby rendering at least one of the halves independent of the containment and control means.

3. Equipment as in claim 2, wherein the containment and control means further comprise a first frame surrounding a peripheral outer portion of both mold halves, when in a closed configuration of contact one with another, and supporting the at least one inflatable element internally.

4. Equipment as in claim 2, wherein the release means are interposed between the two halves of the mold and the at least one inflatable element and connected to the first frame, in such a way as to create a predetermined or linear gap by which the two mold halves are afforded a free passage at least when the inflatable element is at rest, in the first limit configuration of minimum pressure and contracted dimensions.

5. Equipment as in claim 3, wherein the first frame is rigidly associated with the outer surface presented by one of the halves of the mold.

6. Equipment as in claim 3, wherein the first frame is furnished with at least two inflatable elements arranged one beside the next along the direction followed by the mold halves when joined to and distanced from one another.

7. Equipment as in claim 3, comprising flow and return means mounted to the first frame, by which the inflatable elements are supplied with and relieved of fluid.

8. Equipment as in claim 2, wherein the release means comprise a movable second frame composed of at least one plate matching the periphery of the first frame at least in part, and associated with the selfsame first frame by way of coupling means in such a way as to establish the gap affording a passage to the halves of the mold when joined to and distanced from one another, and when the at least one inflatable element is at rest, in the first limit configuration of contracted dimensions.

9. Equipment as in claim 8, wherein the coupling means serve to retain the at least one plate and are of passive type.

10. Equipment as in claim 8, wherein the coupling means serve to retain the at least one plate and are of active type.

11. Equipment as in claim 8, wherein the coupling and retaining means comprise a plurality of pins, each positioned on the outer surface of the first frame and passing through a relative clearance socket afforded by the selfsame first frame, in such a way that one end can be associated with the second frame, also a spring, interposed between each pin and the first frame, serving to keep the second frame in close association with the first frame when the at least one inflatable element is at rest, presenting the first configuration of contracted dimensions and, respectively, to adjust or increase the distance between the second frame and the first frame when the at least one inflatable element is in operation, presenting the second configuration of expanded dimensions.

12. Equipment as in claim 8, wherein the coupling and retaining means comprise a plurality of pneumatic cylinders, each positioned on the outer surface of the first frame and passing through a relative clearance socket afforded by the selfsame first frame, in such a way that one end or rod can be associated with the second frame; each of the cylinders governed by a control unit in such a way as to keep the second frame in close association with the first frame when the at least one inflatable element is at rest, presenting the first configuration of contracted dimensions and, respectively, to adjust or increase the distance between the second frame and the first frame when the at least one inflatable element is in operation, presenting the second configuration of expanded dimensions.

13. Equipment as in claim 8, wherein the first frame appears quadrangular when seen in section, and the movable second frame comprises at least four independent plates associated one with each side of the first frame, each furnished with relative coupling means.

14. Equipment as in claim 7, wherein the flow and return means are positioned on the top part of the first frame and insertable through the frame in such a way as to connect in fluid-tight association with the at least one inflatable element.

15. Equipment as in claim 8, wherein the first frame appears circular when seen in section, the movable second frame comprises at least one plate of relative circular geometry combining with the first frame to create a cylindrical assembly positioned to surround a matching cylindrical surface presented by the halves of the mold, and the at least one plate is furnished with relative coupling means.

16. Equipment as in claim 2, comprising:
containment and control means associated with the half of the mold constituting a male component;
first motion-inducing means associated with the male half in such a way as to direct the selfsame half toward and away from a female half via the free passage afforded by the gap created through the agency of the release means operating between the two halves and the at least one inflatable element, thereby obtaining the separation of the female half containing the cast ceramic ware.

17. Equipment as in claim 16, wherein the female half of the mold is furnished with second motion-inducing means by which the selfsame female half can be displaced independently of the male half when distanced therefrom.

18. Equipment as in claim 1, wherein the release means are interposed between the containment and control means and the mold halves, and the containment and control means comprise at least one first frame surrounding a peripheral outer portion of both mold halves when in the configuration of contact one with another.

19. Equipment as in claim 1, wherein the containment and control means comprise a first frame and a plurality of locating plates, mounted to the frame, and arranged so as to surround both of the mold halves peripherally when in the configuration of contact one with another, also means located between the plurality of plates and the first frame, surrounding a peripheral outer portion of both the mold halves, acting on the plurality of plates and constituting release means.

20. Equipment as in claim 19, wherein the plates are at least two in number, and placed to surround the mold halves peripherally when in the configuration of contact one with another.

21. Equipment as in claim 19, comprising a mold of which the halves present a quadrangular peripheral outline, wherein the first frame is of quadrangular geometry and the plates are at least four in number, in such a way as to surround both halves of the mold peripherally when in the configuration of contact one with another.

22. Equipment as in claim 19, wherein the release means comprise motion-inducing mechanisms by means of which the plurality of plates can be moved between an operating position of proximity, in which the plates are offered to the mold halves when in the configuration of contact one with another, and a non-operating position of detachment, in which the plates are distanced from the mold halves so that the selfsame halves can be separated one from another and, if necessary, at least one mold half separated from the first frame.

23. Equipment as in claim 22, wherein the motion-inducing mechanisms comprise at least:
a plurality of hydraulic cylinders associated with each plate, each cylinder associated slidably with a relative mounting presented by the innermost surface of the first frame and anchored by way of a free end to the relative plate;
means connected to the cylinders, by which the selfsame cylinders are activated or deactivated in such a way as to determine the positions in which the plates are located in proximity to or distanced from the mold halves when in the configuration of contact one with another.

24. Equipment as in claim 23, wherein the motion-inducing mechanisms further comprise spring return means, interposed between the first frame and the plates, so as to enable the passage of the plate from the position of proximity to the distanced position.

25. Equipment as in claim 23, wherein the means of activating and deactivating the cylinders are governed by a master controller such as will allow of varying the reaction pressure of each plate on the mold halves when in the position of proximity, by actuating the cylinders, thereby constituting containment means of active type.

26. Equipment as in claim 23, wherein the rod of each cylinder is furnished with an adjustable reaction and stroke-limiting element interposed between the rod and the first frame, in such a way as to establish a predetermined travel between the position of proximity and the distanced position of the plates, thereby constituting containment means of passive type.

27. Equipment as in claim 22, wherein the motion-inducing mechanisms comprise, at least, cam means interposed between the first frame and each plate and connected mechanically by way of relative rods to operating and actuating means combining with the cam means to determine the position of proximity and the distanced position of the plates.

28. Equipment as in claim 27, wherein the cam means comprise a plurality of pivots associated with the single plates, mounted at each end by way of eccentric fulcrum points to vertical side members of the relative plate in such a way that the plate can be displaced perpendicularly to the corresponding face of the mold halves, toward and away from the selfsame halves, by causing the eccentric pivots to rotate through the agency of the operating and actuating means.

29. Equipment as in claim 28, wherein each pivot is associated with one end of a relative lever connected at the other end to a common rod operating all the levers associated with the plate, the rod connected in turn to the relative operating and actuating means.

30. Equipment as in claim 27, wherein the operating and actuating means comprise a cylinder inducing reciprocating linear motion in each rod, thereby causing the plates to assume the positions in proximity to and distanced from the mold halves.

31. Equipment as in claim 30, wherein each cylinder is governed by a master controller serving to establish a predetermined stroke of the cylinder, in each direction, corresponding to the travel between the position of proximity and the distanced position of the plates, thereby constituting containment means of passive type.

32. Equipment as in claim 30, wherein each cylinder is governed by a master controller serving both to establish a predetermined stroke of the cylinder, in each direction, corresponding to the travel between the position of proximity and the distanced position of the plates, and to introduce a further stroke variation dependent on the reaction pressure applicable preferably to the mold halves by each plate when in the position of proximity, thereby creating containment means of active type.

33. Equipment as in claim 18, wherein the first frame is furnished with at least one pair of trolleys running on relative rails presented by a fixed machine frame, and separable means of association with one of the mold halves, so that the activation of motion-inducing means will draw the mold halves together or distance the one half from the other, and when necessary, distance the first frame from the mold half associated with the selfsame first frame.

34. Equipment as in claim 5, wherein the first frame is rigidly associated with one half of the mold by way of separable means such as will allow the selfsame first frame and mold half to be distanced one from another when necessary.

35. Equipment as in claim 1, comprising:
containment and control means associated with the half of the mold constituting a male component;
first motion-inducing means associated with the male half in such a way as to direct the selfsame half toward and away from a female half via the free passage afforded by the gap created through the agency of the release means operating on the containment and control means and on two mold halves, thereby obtaining the separation of the female half containing the cast ceramic ware.
